(19) United States
(12) Patent Application Publication
(10) Pub. No.: US 2009/0218237 A1
(43) Pub. Date: Sep. 3, 2009

(54) LITHIUM ION-SELECTIVE MEMBRANE

(76) Inventors: Martial Berger, Fontenay Aux Roses (FR); Nathalie Costarramone, Monein (FR); Alain Castetbon, Sauveterre (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/298,048

(22) PCT Filed: Apr. 24, 2007
(86) PCT No.: PCT/FR2007/000690

§ 371 Date: Jan. 5, 2009

(30) Foreign Application Priority Data
Apr. 24, 2006 (FR) 0603612

(51) Int. Cl. G01N 27/26; H01B 1/12; C25B 11/04; G01F 1/64

(52) U.S. Cl. 205/781.5; 252/500; 252/519.21; 204/291; 204/415

(57) ABSTRACT

The invention relates to a lithium ion-selective membrane, including a polymer carrier, a plasticizer, a conductive compound and a lithium ion specific ionophoric compound. The invention consists in that said ionophoric compound is dibenzyl-14-crown-4 and derivatives thereof, and represents between 0.5 and 3% by weight of the total composition of the membrane, the polymer carrier representing 25 to 30% by weight of the total composition of the membrane, the plasticizer from 65 to 72% by weight of the total composition of the membrane and the conductive compound from 0.2 to 1.5% by weight of the total composition of the membrane. Said invention can be used to determine the lithium ion concentration of a fluid, such as a primary fluid for a pressurized water reactor in a nuclear power plant.

The present invention concerns a lithium ion-selective membrane, a lithium-ion selective electrode containing such a membrane and a device equipped with such an electrode making possible measurement of the lithium concentration in a fluid such as the fluid of the primary cooling circuit of a pressurized water reactor of a nuclear power plant.

In nuclear pressurized water reactors, the core of the reactor consists of rod assemblies containing pellets enriched with fissible material subjected to a neutron flow making it possible to liberate the energy of nuclear fissions. To control the activity of the reactor, boric acid used in the fluid of the primary circuit to regulate the neutron flow is introduced, the isotope 10 of the boron atom of the boric acid molecule possessing, in fact, as “neutron poison,” the property of absorbing the neutrons.

The boron 10 atom concentration also depends on the fuel depletion and power variation of the reactor.

However, the use of boric acid creates a number of generalized corrosion phenomena, such as the generation of radio-elements resulting from corrosion, which migrate to singular zones of the primary circuit. In fact, under the operating conditions of the reactor (mean temperature of 303° C.), the pH of the primary fluid comes within a range in which a generalized corrosion of the contact materials (austenitic steels, notably) is produced, characterized by the release and transport of corrosion products activated under neutron flow by passage into the core of the reactor. These activated products, emitters of gamma and beta radiation, are responsible for most of the doses received by personnel, notably, during the maintenance work performed on section shutdowns.

Furthermore, in some particular operating situations, disturbances can occur in the distribution of neutron flow and, therefore, disturbances in fuel performance, as well as a disturbance of hydraulic flow of the primary circuit associated with the presence of corrosion products.

To solve this problem, a pH of the primary circuit should be maintained at a reference value called “least corrosion,” that is, for a temperature of 300° C., an expected pH value situated between 7.2 and 7.4 according to international recommendations. To maintain that pH at a desired reference value, a base for fixing pH is introduce in the primary cooling circuit by partially neutralizing the boron, that base being lithine or lithium hydroxide (LiOH), which by itself entails little problem of corrosion.

To maintain the pH at its set value, it is necessary to respect a law of variation of lithine and boron concentration, better known by the specification name of decreasing lithine. In order to do so, measurements must be taken of the lithium concentration in the primary cooling circuit. Thus, as is notably described in document EP-A-0,094,884, a water sample is taken in the primary circuit and the lithium concentration is measured by atomic spectrometry. If the lithium concentration is unsatisfactory, notably, if the primary fluid needed borications and dilutions on power variations, the latter is adjusted in the circuit in the form of an addition of lithine or elimination of excess lithium, and then a control measurement is repeated. However, all of these operations are relatively cumbersome, since it is necessary to have a laboratory available to house the equipment necessary for use of that measurement by atomic spectrometry. In addition, this equipment is relatively expensive, notably necessitating costly consumables (gases and calibrations) and requires recognized technical skill on the part of the operator in charge of the measurement, as well as a lengthy application time. Consequently, such a measurement is generally carried out only twice a day at most, adjustment of the concentration then not taking place with sufficient precision.

Document EP-A-0,294,283 also describes a method of measurement of lithium concentration in the primary cooling circuit of a pressurized water reactor, in which the total electric conductivity of the cooling water of same is measured, in order to then determine the lithium concentration at a measured temperature t, according to the equation:

[Li⁺]0,1·[λ₁+(0.223·[Li→r]+0.03)·(25−t)]+β

β representing, notably, a corrective term, taking into account the presence of possible impurities in the cooling water of the primary circuit, the term β being determined by periodic auxiliary measurement of the lithium concentration by atomic spectrometry. Consequently, this method and the apparatus for its use make it impossible to totally dispense with atomic spectrometry and, therefore, still require the presence of the necessary equipment in situ.

Also known are potentiometric electrodes equipped with lithium-ion selective membranes mainly employed in biological analyses.

Thus, document EP 0,551,769 describes a notably lithium ion-selective electrode usable for analyses in biological media. This electrode has a lithium ion-selective membrane containing as ionophore 6,6-dibenzyl-14-crown-4 ether, as polymer carrier polyvinyl chloride (PVC) in a proportion greater than 40% by weight of the total composition, and as plasticizer nitrophenyl octyl ether associated with trioctyl phosphate, all in a proportion higher than 60%, as well as a potassium tetrakis (p-chlorophenyl) borate in a proportion less than 1%.

Document U.S. Pat. No. 6,508,921 describes an electrode equipped with a lithium ion-selective membrane containing 6,6-dibenzyl-14-crown-4 ether (2%), PVC (30 to 40%) and nitrophenyl octyl ether (40 to 60%) associated with trioctyl phosphate (5 to 15%), as well as potassium tetrakis (p-chlorophenyl) borate (0.1%).

Document WO 93/09427 describes a cation-sensitive electrode comprising, notably, a cation-sensitive membrane containing as ionophore of lithium 6,6-dibenzyl-14-crown-4 ether (0.66%) as PVC polymer (33%), as well as potassium tetrakis (p-chlorophenyl) borate as conductive agent (0.044%), the plasticizer being an adipate, representing approximately 66% by weight of the total composition.

All these membranes are usable for biological analyses. However, it was observed that they could not be used to take measurements of the lithium concentration in the primary cooling circuit, a highly radioactive medium.

The main object of the present invention is, therefore, to propose a device for measurement of the lithium concentration, particularly in the cooling circuit of the pressurized water reactor of a nuclear power plant, which would be particularly simple to use, such as a potentiometric measurement of the lithium concentration, especially by means of a new lithium ion-selective electrode.

In particular, it is advisable for the measuring device and especially the electrode to conform to particular technical criteria linked to the specific environment of use, that is, in a nuclear power plant. Notably, the electrode and, in particular, the membrane equipping that electrode should not be sensitive to irradiation.

For this purpose, the first object of the invention is to propose a lithium ion-specific membrane having very high specificity characteristics and, notably, irradiation resistance characteristics enabling it to be used with fluid taken from the primary cooling circuit of a pressurized water reactor of a nuclear power plant.

A second object of the invention is to make an electrode containing such a membrane so as to be lithium-ion selective and which can be used also with primary fluid taken from the primary circuit of a pressurized water reactor of a nuclear power plant.

A third object is to propose a device for measuring the lithium concentration by potentiometry, involving a lithium ion-selective electrode and a so-called comparison electrode, the potential of which would be fixed as constant, this device having to be usable to measure the lithium concentration in the primary cooling circuit of a pressurized water reactor.

A fourth object is to propose a device for measuring the lithium concentration by potentiometry, involving a lithium ion-selective electrode which would not be interfered with by the species customarily contained in the primary cooling circuit of a pressurized water reactor and, therefore, would not necessitate any particular treatment of the latter.

The membrane of the lithium ion-selective electrode should thus be usable under special conditions and, notably, have irradiation resistance characteristics, taking its environment of use into account.

The primary object of the present invention is therefore a lithium ion-selective membrane, comprising a polymer carrier, a plasticizer, a conductive compound as well as a lithium ion-specific ionophoric compound, characterized in that said ionophoric compound is dibenzyl-14-crown-4 and its derivatives and represents between 0.5 and 3% by weight of the total composition of the membrane, the polymer carrier representing 25 to 30% by weight of the total composition of the membrane, the plasticizer from 65 to 72% by weight of the total composition of the membrane and the conductive compound from 0.2 to 1.5% by weight of the total composition of the membrane.

The dibenzyl-14-crown-4 presents the structural formula:

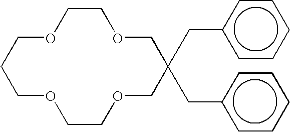

Hence, an electrode equipped with such a membrane according to the invention has a very high lithium specificity, the dibenzyl-14-crown-4 presenting a very high capacity of reversible trapping of lithium ions.

The structure of this ionophoric compound constituting a “cavity” surrounded by polar groups (existence of dipoles), which by analogy behaves like a “lock” in which the lithium ion prevents the steric obstruction of its hydration sphere and its load, would play the “key” role.

The polymer carrier is preferably polyvinyl chloride (PVC).

The plasticizer is preferably NPOE (o-nitrophenyl octyl ether).

The conductive compound is KTpCIPB (potassium tetrakis [p-chlorophenyl]borate).

According to a preferred embodiment, the membrane contains 0.8 to 2% dibenzyl-14-crown-4, 27 to 30% PVC, 65 to 71% NPOE and 0.5 to 1.4% KTpCIPB, the percentages representing the percentage of each constituent by weight of the total composition of the membrane.

It could be verified that a membrane according to the invention very advantageously possesses unaltered qualities under irradiation, which enable that membrane to be safely used in a nuclear environment.

In fact, it could be observed that under an integrated irradiation dose of 320 Gy (i.e., 32000 rad), which is considerable, the behavior of the member was not notably modified.

Another object of the invention concerns the method of manufacture of such a membrane, characterized in that it consists of completely dissolving the polymer carrier, the plasticizer, the conductive compound and the dibenzyl-14-crown-4 in tetrahydrofuran (THF) under magnetic agitation at ambient temperature, decanting the clear solution obtained in order to crystallize it by evaporation of the THF and recovering the membrane thus formed.

The present invention also concerns a lithium ion-selective electrode comprising an internal reference element consisting of a silver wire coated with silver chloride (AgCl) and an internal solution of lithium chloride as well as a lithium ion-selective membrane, characterized that the membrane is the same as that previously mentioned.

In a preferred embodiment of the electrode according to the invention, the latter consists of an electrode body, a connector plug and a housing for the membrane, those three parts constituting the electrode being made of polyacetal (also called polyoxymethylene) (POM).

The connector plug being POM, it is advantageously possible to solder directly a silver wire coated with silver chloride (AgCl) as internal reference element. This internal reference element extends into the body of the electrode containing the lithium chloride solution.

The housing for the membrane is created in a case having a structure offering easy and rapid replacement of the membrane. That case thus consists of a carrier on which the membrane is reversibly attachable by means of a cap.

In a preferred embodiment, the carrier contains a cavity in which the membrane can be inserted, the cap attaching the membrane being crossed by a cone-shaped channel, the less flared part of which is situated on the side of the membrane, so that when the electrode is dipped in a solution, a thin film of solution to be measured is in contract with the membrane. A better precision of measurement is thus obtained for low concentrations of the ion to be measured.

The membrane thus has very satisfactory stability at the temperatures of the primary fluid sample taken for measurement of the lithium, that is, at temperatures within a range of up to 45° C.

In addition, the membrane according to the invention makes possible a constant operation of the electrode, regardless of the boric acid concentration contained in the fluid measured.

Likewise, the membrane according to the invention has a high selectivity to lithium ions just as the presence of other catons such as sodium (Na⁺), potassium (K⁺) and ammonium (NH₄⁺) which have almost no influence on operation of the electrode according to the invention. The lithium ion-selective electrode will not undergo any interferences by the species contained in the primary cooling circuit of a pressurized water reactor and, accordingly, the latter will not require any particular treatment.

A lithium ion-selective electrode according to the invention can advantageously be used to determine the lithium concentration of an aqueous solution by potentiometry.

The present invention also concerns a device for measurement of the lithium ion concentration in an aqueous medium such as the fluid of the primary cooling circuit of a pressurized water reactor, characterized in that it contains a first so-called comparison measurement electrode permanently dipped in a lithium ion reference solution, the potential of which is constant, and a second lithium ion-selective measurement electrode according to the invention, dipped in the solution to be measured, both solutions being connected by a saline bridge and means of measurement of the potential difference between the two electrodes, as well as means of analysis and calculation of the lithium ion concentration based on the potential difference measured.

The measuring device according to the invention thus very advantageously makes it possible to determine the lithium ion concentration quickly and reliably from the potential difference between the two electrodes, the potential developed by a selective electrode dependent on the activity (therefore, on the concentration) of a given ion, Li⁺ here, obeying Nernst's law:

$$E = {E}_{0} + ( \frac{R \cdot T}{n \cdot F} ) Ln [ {Li}^{+} ]$$

in which E is the potential developed at any instant by the electrode (V), E₀ is the standard potential of the electrode (V), R is the constant of the perfect gases (8.31 J⁻¹.K.mole⁻¹), T is the temperature in K, n is the valence of Li⁺, n being equal here to 1, F is Faraday's constant (96500 C) and [Li⁺] is the activity (comparable to concentration) in Li⁺ at eq.1⁻¹ in the range of concentration used in the primary fluid.

The measurement being simple to perform, the concentration of lithium dissolved in the primary fluid of a pressurized water reactor can be regularly and frequently monitored, which was not the case with atomic spectrometry.

According to a preferred embodiment of the invention, the so-called comparison electrode would consist of any external reference electrode whose potential is fixed constant for the above-mentioned conditions of measurement.

The means of measurement, analysis and calculation are advantageously constituted by an ionometer.

Daily recalibration of the device can be easily made by simply bringing the measurement electrode in contact with a lithium solution of composition identical to the reference lithium solution, the resultant potential difference having to be nil; it is sufficient to regulate the means of measurement and/or of analysis and/or of calculation in order to recalibrate the device correctly according to the invention.

Consequently, a device according to the invention offers a simple and economical solution to be applied for determining the lithium concentration of a fluid, no longer necessitating heavy equipment like that required by atomic spectrometry.

The invention also concerns a method of determination of the lithium ion concentration of a fluid, such as a primary fluid of a pressurized water reactor of a nuclear power plant, characterized in that it consists of measuring the potential difference between a lithium ion-selective electrode, the latter comprising a reference element, an internal solution of lithium chloride, as well as a lithium ion-selective membrane comprising a polymer carrier, a plasticizer, a conductive compound, as well as dibenzyl-14-crown-4 and its derivatives, as lithium ion-specific ionophoric compound, representing between 0.5 and 3% by weight of the total composition of the membrane, the polymer carrier representing 25 to 30% by weight of the total composition of the membrane, the plasticizer from 65 to 72% by weight of the total composition of the membrane and the conductive carrier from 0.2 to 1.5% by weight of the total composition of the membrane, dipped in the solution whose lithium concentration is measured and a comparison electrode dipped in that same solution and determining the lithium concentration from that measurement of potential difference between those two electrodes, which obeys Nernst's law.

The invention will now be described more in detail with reference to working examples and to the drawing, in which:

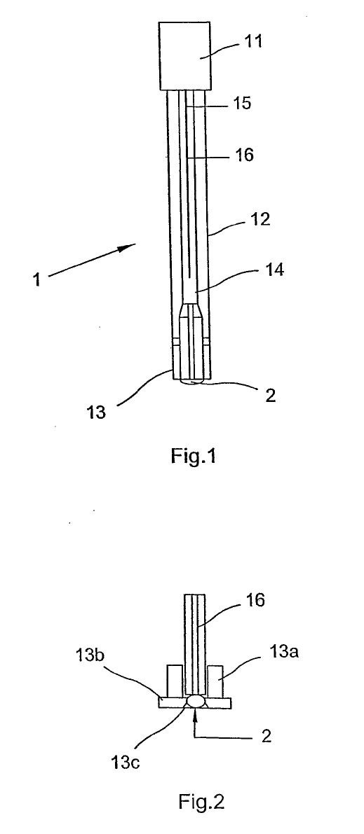

FIG. 1 represents a cutaway view of an electrode according to the invention;

FIG. 2 represents a cutaway view of the case of the electrode in which the membrane is fixed according to the invention; and

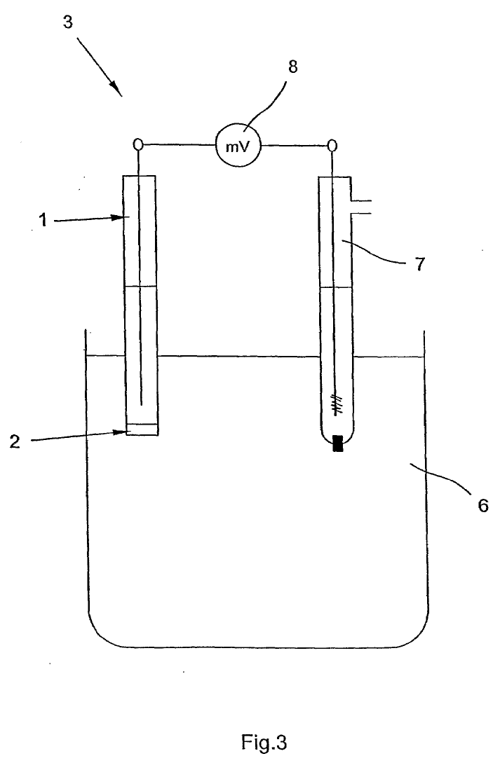

FIG. 3 schematically represents a measuring device according to the invention.

As can be seen in FIG. 1, the electrode 1 according to the invention has a plug 11 comprising a coaxial connector, an electrode body 12 and a case 13 for the membrane 2 according to the invention.

The electrode body 12 defines a channel 14 in which is located an internal reference electrode consisting of a silver wire 15 coated with silver chloride (AgCl) and dipped in an internal solution 16 of lithium chloride LiCl.

The case 13 consists of a carrier 13a defining a housing for the membrane 2 and in which a cap 13b is positioned to reversibly fix the membrane 2. This cap 13b is bored with a cone-shaped channel 13c making possible the formation of a very fine film of internal solution on the membrane 2.

Such an electrode 1 then makes it possible to produce a device for measurement 3 of the lithium ion concentration in solution in an aqueous fluid.

The solution to be measured 6 is preferably subjected to magnetic agitation. An electrode 1, equipped with the lithium ion-selective membrane 2 and a reference electrode 7 according to the invention, is dipped in that solution to be measured 6. The two electrodes 1 and 7 are connected to an ionometer 8.

It goes without saying that the embodiment of the invention described above was given purely by way of indication and with no limitation and that numerous modifications can be easily introduced by the expert without thereby departing from the scope of the invention.

1. A lithium ion-selective membrane, comprising a polymer carrier, a plasticizer, a conductive compound and a lithium ion-specific ionophoric compound, characterized in that said ionophoric compound is dibenzyl-14-crown-4 and its derivatives and represents between 0.5 and 3% by weight of the total composition of the membrane, the polymer carrier representing 25 to 30% by weight of the total composition of the membrane, the plasticizer from 65 to 72% by weight of the total composition of the membrane and the conductive compound from 0.2 to 1.5% by weight of the total composition of the membrane.

2. The membrane according to claim 1, characterized in that the polymer carrier is polyvinyl chloride (PVC).

3. The membrane according to claim 1, characterized in that the plasticizer is NPOE (o-nitrophenyl octyl ether).

4. The membrane according to claim 1, characterized in that the conductive compound is potassium tetrakis (p-chlorophenyl) borate.

5. The membrane according to claim 1, characterized in that it contains 0.8 to 2% dibenzyl-14-crown-4, 27 to 30% PVC, 65 to 71% NPOE and 0.5 to 1.4% KTpCIPB, the percentages representing the percentage of each constituent by weight of the total composition of the membrane.

6. A method of manufacturing a lithium ion-selective membrane, comprising the steps of:
completely dissolving a polymer carrier, a plasticizer, a conductive compound and dibenzyl-14-crown-4 in tetrahydrofuran (THF) under magnetic agitation at ambient temperature, and
decanting a clear solution obtained in order to crystallize it by evaporation of the THF at ambient temperature and recovering the membrane formed.

7. A lithium ion-selective electrode, intended in particular for measurement of the concentration of lithium dissolved in the fluid of a primary circuit of a pressurized water reactor of a nuclear power plant, comprising an internal reference element comprising a silver wire coated with silver chloride (AgCl), an internal solution of lithium chloride and a lithium ion-selective membrane comprising a polymer carrier, a plasticizer, a conductive compound and a lithium ion-specific ionophore, characterized in that said ionophoric compound is dibenzyl-14-crown-4 and its derivatives and represents between 0.5 and 3% by weight of the total composition of the membrane, the polymer carrier representing 25 to 30% by weight of the total composition of the membrane, the plasticizer from 65 to 72% by weight of the total composition of the membrane and the conductive compound from 0.2 to 1.5% by weight of the total composition of the membrane.

8. The electrode according to claim 7, characterized in that it comprises an electrode body, a connector plug and a case provided with a housing for the membrane, those three parts being preferably constituted by polyacetal.

9. The electrode according to claim 8, characterized in that the case provided with a housing for the membrane comprises a carrier containing a cavity in which the membrane can be inserted, a cap is reversibly fixable on the carrier to attach the membrane being traversed by a channel.

10. The electrode according to claim 9, characterized in that the channel is cone-shaped, the least flared part being on the side of the membrane.

11. A device for measurement of a lithium ion concentration of a fluid such as the fluid of a primary cooling circuit of a pressurized water reactor, characterized in that it contains a first so-called comparison measurement electrode permanently dipped in a lithium ion reference solution of constant potential and a second lithium ion-selective measurement electrode dipped in the solution to be measured, and means of measurement of the potential difference between the two electrodes, as well as means of analysis and calculation of the lithium ion concentration based on the potential difference measured.

12. A method of determination of a lithium ion concentration of a fluid, such as a primary fluid of a pressurized water reactor of a nuclear power plant, comprising the steps of:
measuring a potential difference between a lithium ion-selective electrode, the latter comprising a reference element, an internal solution of lithium chloride, as well as a lithium ion-selective membrane comprising a polymer carrier, a plasticizer, a conductive compound, as well as dibenzyl-14-crown-4 and its derivatives, as lithium ion-specific ionophoric compound, representing between 0.5 and 3% by weight of the total composition of the membrane, the polymer carrier representing 25 to 30% by weight of the total composition of the membrane, the plasticizer from 65 to 72% by weight of the total composition of the membrane and the conductive carrier from 0.2 to 1.5% by weight of the total composition of the membrane,
dipping the ion-selective electrode in a solution whose lithium concentration is measured,
dipping a comparison electrode the solution, and
determining the lithium concentration from the potential difference between the ion-selective electrode and the comparison electrode, which obeys Nernst's law.

13. The device according to claim 11, wherein the lithium ion-selective electrode comprises an internal reference element having a silver wire coated with silver chloride (AgCl), an internal solution of lithium chloride and a lithium ion-selective membrane comprising a polymer carrier, a plasticizer, a conductive compound and a lithium ion-specific ionophore, the ionophoric compound is dibenzyl-14-crown-4 and its derivatives and represents between 0.5 and 3% by weight of the total composition of the membrane, the polymer carrier representing 25 to 30% by weight of the total composition of the membrane, the plasticizer from 65 to 72% by weight of the total composition of the membrane and the conductive compound from 0.2 to 1.5% by weight of the total composition of the membrane.

14. The device according to claim 11, wherein the electrode comprises an electrode body, a connector plug and a case provided with a housing for the membrane, those three parts being preferably constituted by polyacetal.

15. The device according to claim 14, wherein the case includes a carrier containing a cavity in which the membrane can be inserted, a cap is reversibly fixable on the carrier to attach the membrane being traversed by a channel.
